(19) United States
(12) Patent Application Publication
(10) Pub. No.: US 2025/0183415 A1
(43) Pub. Date: Jun. 5, 2025

(54) TRACTION BATTERY PACK THERMAL MANAGEMENT SYSTEM AND THERMAL MANAGEMENT METHOD

(71) Applicant: Ford Global Technologies, LLC, Dearborn, MI (US)

(72) Inventor: Xiaogang Zhang, Novi, MI (US)

(21) Appl. No.: 18/528,456

(22) Filed: Dec. 4, 2023

(51) Int. Cl. H01M 10/6568; H01M 10/625; H01M 10/647; H01M 50/211; H01M 50/244; H01M 50/249

(52) U.S. Cl. CPC H01M 10/6568; H01M 10/625; H01M 10/647; H01M 50/211; H01M 50/244; H01M 50/249; H01M 2220/20

(57) ABSTRACT

A traction battery pack includes an enclosure assembly providing an interior and at least one cell stack housed within the interior. The at least one cell stack includes a plurality of battery cells. A first coolant manages thermal energy within the interior, and a second coolant that manages thermal energy within the interior. The second coolant is a different type of coolant than the first coolant.

### TECHNICAL FIELD

This disclosure details exemplary methods and assemblies that utilize more than one type of coolant to help to manage thermal energy within a battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. Coolant can be moved through the traction battery pack to help manage thermal energy within the traction battery pack.

### SUMMARY

In some aspects, the techniques described herein relate to a traction battery pack, including: an enclosure assembly providing an interior; at least one cell stack housed within the interior, the at least one cell stack including a plurality of battery cells; a first coolant that manages thermal energy within the interior; and a second coolant that manages thermal energy within the interior, the second coolant a different type of coolant than the first coolant.

In some aspects, the techniques described herein relate to a traction battery pack, wherein the first coolant is less conductive than the second coolant.

In some aspects, the techniques described herein relate to a traction battery pack, wherein the at least one cell stack includes conductive features that are submerged within the first coolant.

In some aspects, the techniques described herein relate to a traction battery pack, wherein the conductive features include terminals of the plurality of battery cells within the at least one cell stack.

In some aspects, the techniques described herein relate to a traction battery pack, wherein the first coolant is a dielectric coolant.

In some aspects, the techniques described herein relate to a traction battery pack, wherein the first and second coolants are first and second liquid coolants.

In some aspects, the techniques described herein relate to a traction battery pack, further including a sealing system within the interior, the sealing system separating the interior into a first volume that contains the first coolant and a different, second volume that contains the second coolant.

In some aspects, the techniques described herein relate to a traction battery pack, wherein the plurality of battery cells are configured to vent into the first volume.

In some aspects, the techniques described herein relate to a traction battery pack, wherein the sealing system includes at least one sealing ring circumscribing one or more of the battery cells within the plurality of battery cells.

In some aspects, the techniques described herein relate to a traction battery pack, wherein the at least one sealing ring seals an interface between a surface of at least one of the battery cells within the plurality of battery cells and the enclosure assembly.

In some aspects, the techniques described herein relate to a method of managing thermal energy levels within a battery pack, including: circulating a first coolant through a first volume within an interior of a battery pack; and circulating a second coolant through a second volume within the interior of the battery pack, the second coolant a different type of coolant than the first coolant.

In some aspects, the techniques described herein relate to a method, wherein the first coolant is less conductive than the second coolant.

In some aspects, the techniques described herein relate to a method, wherein the first coolant is a liquid dielectric.

In some aspects, the techniques described herein relate to a method, further including sealing the first volume from the second volume to block the first coolant from entering the second volume, and to block the second coolant from entering the first volume.

In some aspects, the techniques described herein relate to a method, wherein a plurality of terminals of battery cells within the interior of the battery pack are positioned within the first volume.

In some aspects, the techniques described herein relate to a method, wherein the first volume is separate and distinct from the second volume.

In some aspects, the techniques described herein relate to a method, wherein components of the battery pack that are configured as electrical conductors are disposed within the first volume.

In some aspects, the techniques described herein relate to a method, wherein a plurality of battery cells within the interior of the battery pack are positioned such that vents of the plurality of battery cells open to the first volume.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1 along with an immersion thermal management system.

FIG. 3 illustrates a section view taken at line 3-3 in FIG. 2.

FIG. 4 illustrates a perspective and partially expanded view of the battery pack of FIG. 2.

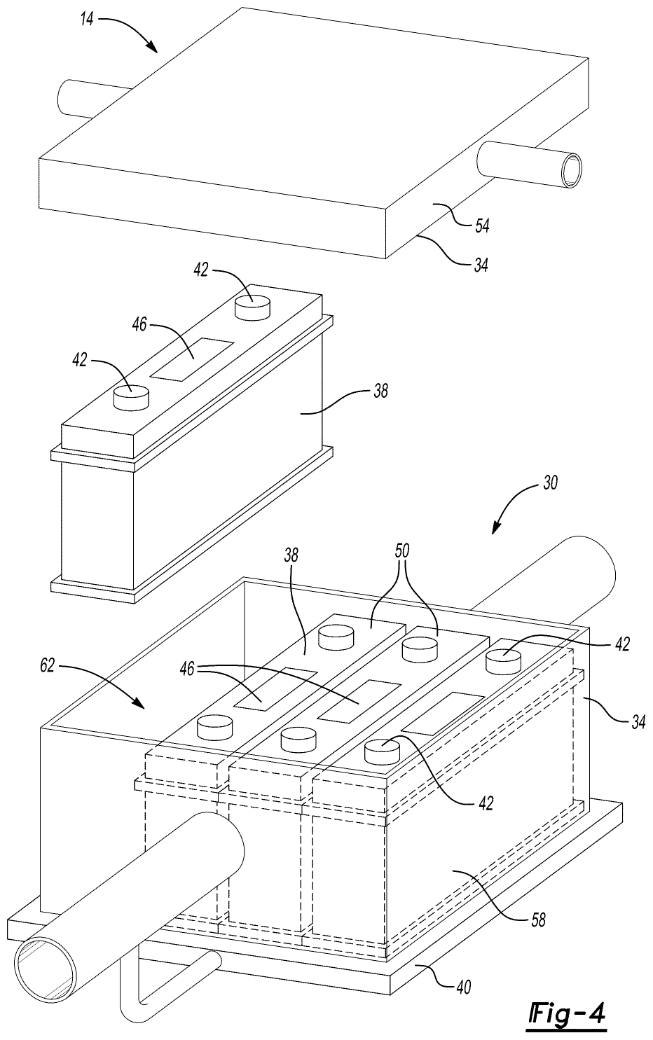

### DETAILED DESCRIPTION

An immersion thermal management system can be used to manage thermal energy in a battery pack. This disclosure is directed toward an immersion thermal management system that uses different types of coolant. In an example, a coolant, such as a dielectric liquid, can be used to manage thermal energy in some areas. Another type of coolant, perhaps a water/glycol mix, is used to manage thermal energy in other areas.

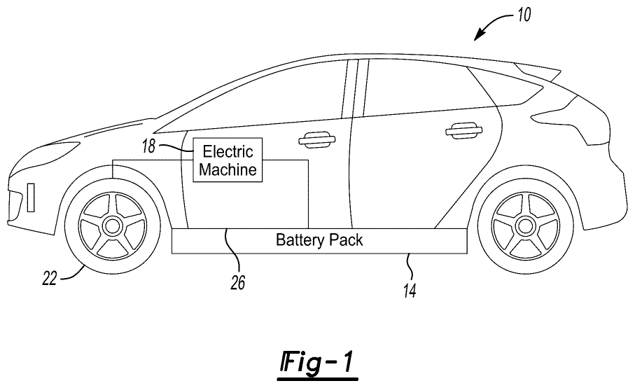

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

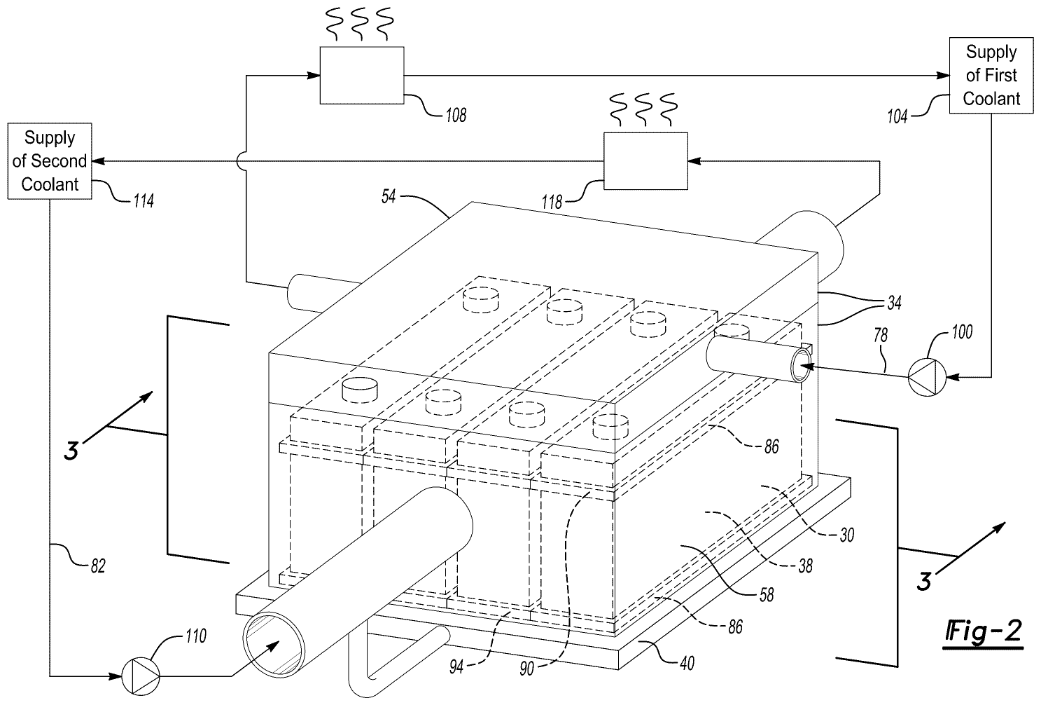

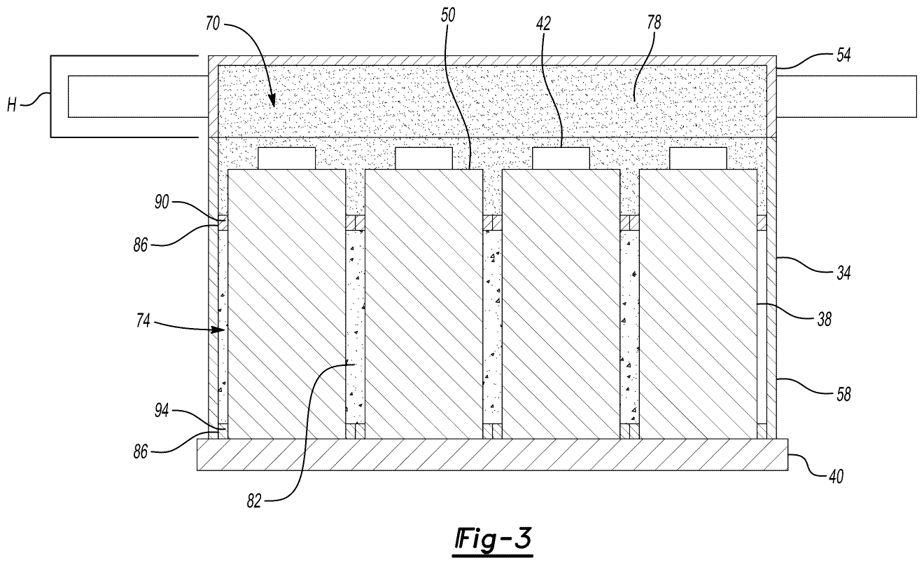

With reference now to FIGS. 2-3 and continuing reference to FIG. 1, the traction battery pack 14 includes at least one cell stack 30 housed within an enclosure assembly 34. The exemplary cell stack 30 includes four individual battery cells 38 that are stacked side-by-side relative to one another to provide the cell stack 30. The cell stack 30 can vary significantly in size, shape, and configuration within the scope of this disclosure. The cell stack 30 and the enclosure assembly 34 can be disposed on a cooling plate 40.

Although only the single cell stack 30 is shown, the traction battery pack 14 could include any number of cell stacks 30 having any number of individual cells 38. In other words, the disclosure is not limited to the specific configuration of cells 38 and cell stacks 30 shown in the figures.

In the exemplary embodiment, the battery cells 38 are lithium-ion pouch cells. However, battery cells having other geometries (cylindrical, etc.), chemistries (nickel-metal hydride, lead-acid, etc.), could be alternative utilized within the scope of this disclosure. The battery cells 38 are for supplying electrical power to various components of the electrified vehicle 10.

The battery cells 38 of the example battery pack 14 each include a pair of terminals 42 and a vent 46. The terminals 42 and the vents 46 are disposed on a vertically upper sides 50 of the battery cells 38. Vertical, for purposes of the disclosure, is with reference to ground and an ordinary orientation of the battery pack 14 in the electrified vehicle 10.

In the exemplary embodiment, the enclosure assembly 34 includes a lid 54 that secures to a tray 58 to provide an interior area 62 that houses the cell stack 30. The lid 54 can be bolted to the tray 58. The lid 54 can be connected to the tray 58 using fluid-tight connection techniques, such as adhesives or welds in other examples. The enclosure assembly 34 can vary significantly in size, shape, and configuration from the enclosure assembly 34 shown.

The battery pack 14 relies on an immersion thermal management system to manage thermal energy levels within the battery pack 14. The immersion thermal management system utilizes different types of coolant. One type of coolant utilized within the immersion thermal management system is appropriate for managing thermal energy levels of components that are configured as electrical conductors of the battery pack 14. Another type of coolant utilized within the immersion thermal management system is used to manage thermal energy levels of other components of the battery pack 14.

In this example, at least at the terminals 42 are conductive features of the battery pack 14. Other exemplary conductive features of the battery pack 14 could include busbars (not shown) coupled to the terminals 42.

The interior area 62 of the enclosure assembly 34 is separated into a first volume 70 and a second volume 74. The immersion thermal management system circulates a first coolant 78 through the first volume. The first coolant 78 is a dielectric liquid. The immersion thermal management system circulates a second coolant 82 through the second volume.

The first volume 70 and the second volume 74 are established such that the components of the battery pack 14 that are configured as electrical conductors are disposed within the first volume 70, not the second volume 74. Thus, any electrically conducting components of the battery pack 14 that are immersed in coolant are immersed in the first coolant 78. At least some of the electrically conducting components are submerged within the first coolant 78 that is within the first volume 70.

The second coolant 82 within the second volume 74 is not the same as the first coolant 78. The second coolant 82 may not be a dielectric liquid. The second coolant 82 could, for example, be a 50/50 mix of water and glycol. As the second coolant 82 is used to manage thermal energy levels of components within the second volume 74 that are not electrically conducting components, the second coolant 82 is not required to be a dielectric liquid.

A sealing system 86 is utilized to fluidly separate the first volume 70 from the second volume 74 within the interior area 62. The first volume 70 is separate and distinct from the second volume 74.

The sealing system 86 can keep the first coolant 78 contained within the first volume 70 within the battery pack 14, and can keep the second coolant 82 contained within the second volume 74 when contained within the battery pack 14. The sealing system 86 blocks the first coolant 78 from entering the second volume 74 and the second coolant 82 from entering the first volume 70.

The sealing system 86 includes, in this example, a plurality of first sealing rings 90 that circumscribe each individual battery cell 38, and a plurality of second sealing rings 94 that circumscribe each individual battery cell 38. The first sealing rings 90 fluidly separates the first volume 70 from the second volume 74. The first sealing rings 90 can be compressed and can seal interfaces between outer surfaces of the battery cells 38 and the enclosure assembly 34. The first sealing rings 90 are positioned such that the first volume 70 has a height H of about five millimeters in this example. The second sealing rings 94 seal interfaces along vertical bottoms of the battery cells 38. The second sealing rings 94 can help to maintain gaps and spacing between the battery cells 30.

The thermal management system incorporates a first pump 100, a first coolant supply 104, and a first thermal exchange device 108. The first pump 100 can be activated to circulate the first coolant 78 along a coolant loop passing through the first volume 70, first pump 100, first coolant supply 104, and the first thermal exchange device 108. When passing through the first volume 70, the first coolant 78 can take on thermal energy from components of the battery pack 4 within the first volume 70, including those components that are conductive such as the terminals 42.

After taking on thermal energy within the first volume 70, the first pump 100 circulates the first coolant 78 to the first thermal exchange device 108. At the first thermal exchange device 108, thermal energy can be released from the first coolant 78 to the air. The first coolant 78 can then be pumped back into the first coolant supply 104 and circulated back through the first volume 70 to remove additional thermal energy.

A control module (not shown) can be incorporated within the electrified vehicle 10 to control activation of the first pump 100. The control module could, for example, activate the first pump 100 only under certain conditions, such as when a sensor within the battery pack 14 detects temperature within the first volume 70 that has exceeded a threshold level.

The coolant system further includes a second pump 110, a second coolant supply 114, and a second thermal exchange device 118. The second pump 110 can be activated to circulate the second coolant 82 along another coolant loop through the second volume 74, second pump 110, second coolant supply 114, and the second thermal exchange device 118. When passing through the second volume 74, the second coolant 82 can take on thermal energy from components of the battery pack 14 within the second volume 74.

After taking on thermal energy within the second volume 74, the second pump 110 circulates the second coolant 82 to the second thermal exchange device 118. Thermal energy is released from the second coolant 82 at the second thermal exchange device 118. The second coolant can then be added to the second coolant supply 114 and, as required circulated back through the second volume 74 to remove additional thermal energy. Like the first pump 100, the control module can control activation of the second pump 110. When passing through the second volume 74, the second coolant 82 can impinge along the smaller sides of the battery cells 30 and then flow along the larger sides of the battery cells 30. Some of the second coolant 82 bypasses the second volume 74 and instead is directed through the cooling plate 40.

Referring again to the vents 46 of the battery cells 38, the vents 46 are positioned to open into the first volume 70 and into the first coolant 78 within the first volume. The first coolant can be configured to be a coolant appropriate for receiving vent byproducts from the cells 38 that pass to the first volume 70 through vents 46 of the cells 38. These vent byproducts can, in some examples, include potentially electrically conductive particles and debris. Internal areas of the battery cells 38 can also be electrically conductive.

As understood, one or more individual cells 38 can vent during a thermal event causing vent byproducts to be released from within that one or more battery cells 38 through the respective vents 46 into the first coolant 78. Since the first coolant 78 is, in this example, a dielectric liquid, the fluid potentially entering internal areas of the battery cells 38 through the vents 46 presents no issue with respect to electrical conductivity.

While the first coolant 78 and the second coolant 82 remove thermal energy from the battery pack 14 in this example. In another example, the first coolant 78, the second coolant 82, or both can be used to add thermal energy (i.e., heat) the battery pack 14. The two coolant loops move perpendicularly to one another within the battery pack 14. The two coolant loops could be oriented differently in other examples.

In some examples, the second coolant 82 is circulated through the second volume 74 under most or all operating conditions. A flow rate for the second coolant 82 can be adjusted based on a temperature within the second volume 74. The flow rate can be relatively low when the measured temperature is below 60 degrees Celsius. The flow rate can be set at an intermediate level when the measured temperature within the second volume 74 is between from 60 to 80 degrees Celsius. The flow rate can be set relatively high when the measured temperature is above 80 degrees Celsius.

The first coolant 78, in contrast to the second coolant 82 is only circulated through the first volume 70 when a temperature in the first volume 70 exceeds a threshold temperature, such as 100 degrees Celsius, or when a temperature in the second volume 74 exceeds a threshold temperature, such as 80 degrees Celsius.

Features of disclosed examples include a battery pack that includes a thermal management system capable of circulating different types of coolant through the battery pack. This can facilitate using less of one type of coolant, such as less dielectric liquid, to manage thermal energy within an immersion thermal management system for a battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack, comprising:
an enclosure assembly providing an interior;
at least one cell stack housed within the interior, the at least one cell stack including a plurality of battery cells;
a first coolant that manages thermal energy within the interior; and
a second coolant that manages thermal energy within the interior, the second coolant a different type of coolant than the first coolant.

2. The traction battery pack of claim 1, wherein the first coolant is less conductive than the second coolant.

3. The traction battery pack of claim 2, wherein the at least one cell stack includes conductive features that are submerged within the first coolant.

4. The traction battery pack of claim 3, wherein the conductive features include terminals of the plurality of battery cells within the at least one cell stack.

5. The traction battery pack of claim 2, wherein the first coolant is a dielectric coolant.

6. The traction battery pack of claim 1, wherein the first and second coolants are first and second liquid coolants.

7. The traction battery pack of claim 1, further comprising a sealing system within the interior, the sealing system separating the interior into a first volume that contains the first coolant and a different, second volume that contains the second coolant.

8. The traction battery pack of claim 7, wherein the plurality of battery cells are configured to vent into the first volume.

9. The traction battery pack of claim 7, wherein the sealing system includes at least one sealing ring circumscribing one or more of the battery cells within the plurality of battery cells.

10. The traction battery pack of claim 9, wherein the at least one sealing ring seals an interface between a surface of at least one of the battery cells within the plurality of battery cells and the enclosure assembly.

11. A method of managing thermal energy levels within a battery pack, comprising:
circulating a first coolant through a first volume within an interior of a battery pack; and
circulating a second coolant through a second volume within the interior of the battery pack, the second coolant a different type of coolant than the first coolant.

12. The method of claim 11, wherein the first coolant is less conductive than the second coolant.

13. The method of claim 11, wherein the first coolant is a liquid dielectric.

14. The method of claim 11, further comprising sealing the first volume from the second volume to block the first coolant from entering the second volume, and to block the second coolant from entering the first volume.

15. The method of claim 11, wherein a plurality of terminals of battery cells within the interior of the battery pack are positioned within the first volume.

16. The method of claim 11, wherein the first volume is separate and distinct from the second volume.

17. The method of claim 11, wherein components of the battery pack that are configured as electrical conductors are disposed within the first volume.

18. The method of claim 11, wherein a plurality of battery cells within the interior of the battery pack are positioned such that vents of the plurality of battery cells open to the first volume.
